(19) United States
(12) Patent Application Publication
(10) Pub. No.: US 2005/0270948 A1
(43) Pub. Date: Dec. 8, 2005

(54) DVD recorder and recording and reproducing device

(75) Inventor: Yoshikazu Fujishima, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/141,042

(22) Filed: Jun. 1, 2005

(30) Foreign Application Priority Data
Jun. 2, 2004 (JP) P2004-164038

(51) Int. Cl. G11B 5/09

(52) U.S. Cl. 369/53.21; 369/47.12; 369/53.2

(57) ABSTRACT

A recording and reproducing device is provided for recording and reproducing data on an optical disk having a cutting data area, which is an area being data rewritable and has data displayed by laser cutting in a radiating direction. In the recording and reproducing device, when an instruction of making reproducing of the optical disk impossible is input, data is deleted along a track by a pickup in a range where the cutting data area is formed in a radius direction of the optical disk.

### BACKGROUND OF THE INVENTION

1. Field of the Invention

The present invention relates to a DVD recorder and a recording and reproducing device that records and reproduces data on an optical disk having a cutting data area, which has the data displayed by laser cutting in a radiating direction

2. Description of the Related Art

To prevent a large amount of data stored in a DVD from being illegally copied, in the context of contents stored in DVD-RW, for example, whether reproducing is available or whether copying is available is managed based on a content projection for recordable media (CPRM) for a video recording format. Thus, information related to managing these is displayed as information recorded in a track of a DVD-RW and information recorded on a narrow burst cutting area (NBCA) by laser cutting (hereinafter, referred to as cutting data) (referred to as a first related art).

In addition, a technology described below is proposed (referred to as a second related art). In other words, this technology discloses that “all areas related to information recording on a medium M1, which is a DVD, includes non-play recording areas (a read-in zone and a read-out zone) 11 and 12, a defect management area (hereinafter, referred to as a DMA) 10a into which bit defect information is registered, a logical format information management area 10c, a management information save regions 11a and 12a in the non-play recording areas 11 and 12, and an information recording area 10. Among these, the non-play recording areas 11 and 12, the DMA 10a, and the logical format information management area 10c are also referred to as a management information area, which is typically a code region where a user cannot reproduce, record, delete, and rewrite information. However, the management information area is accessed through a system such that it is possible to freely make the medium M1 incapable to be reproduced or capable only to be reproduced, or reversely, to perform restoration into rewritable states at any time”.

In addition, it is disclosed that “a reference numeral 10b indicates a logical access area, which is so-called a substantial data recording area, and is an area other than the DMA 10a from the information recording area 10. In the logical access area 10a, a sector registered in a physical defect list (PDL) of the DMA 10a, which is an initial defect list upon physically formatting or testing from the medium M1 manufacturer), is omitted (sector sleeping process), and logical block numbers are allocated from ‘0’ in a consecutive number order to usable sectors. An OS detects the logical block numbers and accesses information on the medium M1, so that when the DMA 10a is not stored in a specified format, or when directory data of the logical format information management area 10c or the logical block number corresponding to the directory data is deleted, the OS cannot access the medium M1. Accordingly, reproducing becomes impossible” (for example, see JP-A-2000-215613. ([0018], [0019], and FIG. 1)).

In addition, the following technology is proposed (referred to as a third related art). In other words, in this technology, an NBCA reservation area is formed in the innermost side of a read-in area, and an initial area starts from a circumferential side adjacent to the NBCA reservation area. In addition, among a buffer area 0 of the read-in area, an RW physical format information area, a reference code area, a buffer area 1 and a control data area, the buffer area 0, the reference code area, the buffer area 1, and the control data area are used for a readable embossed area, where a second identification information can be recorded. In addition, first identification information can be recorded into the NBCA. For this reason, identification information for use in copy protection etc. can be recorded such that a user cannot rewrite the identification information, so that illegal use of the identification information can be prevented (for example, see JP-A-2001-344765 ([0097] to [0101], and FIG. 1)).

### SUMMARY OF THE INVENTION

However, when the first related art is used, the following problems occur. In other words, when the DVD-RW of which reproducing is allowed according to information stored in the NBCA and information stored in a track is discarded, it can be supposed that the discarded DVD-RW passes to another person. In addition, when the discarded DVD-RW passes to another person, it leads to an unwanted situation that the contents of the discarded DVD-RW may be read by another person. For this reason, in case that the DVD-RW is discarded, even when the DVD-RW is a DVD-RW of which reproducing is allowed according to information stored in a NBCA and information stored in a track, a method of reliably making the reproducing impossible is required.

The second related art performs the operation of making the medium incapable to be reproduced or capable only to be reproduced, or the restoring operation into the rewritable state by accessing the management information area, and performs an operation of making the reproducing of the medium impossible by deleting the directory data of the logical format information management area and the logical block number corresponding to the directory data. In other words, by rewriting data along the track, the reproducing becomes impossible. However, when rewriting the data along the track, a possibility of restoring the medium which cannot be reproduced cannot be perfectly deleted, so that a problem occurs in that there still remains a possibility that data can be read.

The third related art allows identification information to be used in copy protection and the like to be recorded such that a user cannot rewrite the identification information, so that illegal use of the identification information is prevented. For this reason, with respect to reliably making the reproducing of the medium impossible, it is difficult to adapt this technology.

It is an object of the invention to provide a DVD recorder, which can change an optical disk corresponding to a CPRM into a disk of which reproducing is impossible, can prevent an unqualified user from perform a process of making reproducing of a DVD impossible, and can prevent the process of making the reproducing of the DVD impossible from being inadvertently performed.

It is an another object of the invention to provide a recording and reproducing device for deleting data by a pickup in a range where a cutting data area is formed in a radius direction of an optical disk, causing the cutting data area to be non-readable, and making one of information, which are necessary for decoding a code of an optical disk that corresponds to the CPRM, not obtainable, thus changing the optical disk that corresponds to the CPRM into a disk of which the reproducing is surely impossible.

It is yet another object of the invention to provide a recording and reproducing device, which can prevent an unqualified user form performing a process of making reproducing of an optical disk impossible by requesting a password input when the process of making the reproducing of the optical disk is performed.

It is a still further object of the invention to provide a recording and reproducing device, which can prevent the process of making the reproducing of the DVD impossible from being inadvertently performed, by requesting to confirm whether to perform the process when the process is performed.

According to one aspect of the invention, a DVD recorder for recording and reproducing data on a DVD having an NBCA in which data is rewritable and the data is displayed by laser cutting in a radiating direction. The DVD recorder has a password storage unit that stores a password inputted in advance. In the DVD recorder, a password input is requested when an instruction of making reproducing of the DVD impossible is input, a display for requesting to confirm whether to perform the process of making the reproducing of the DVD impossible is performed when the input password accords with the password stored in the password storage unit, and data is deleted along a track by a pickup in a range where the NBCA is formed in a radius direction of the DVD when the instruction of performing to make the reproducing of the DVD is input in response to the display.

In other words, in the NBCA, data is displayed by laser cutting in a radiating direction. For this reason, laser light for deletion when a typical data deleting operation is performed is illuminated on the NBCA along the track, and cuttings formed in advance in the radiating direction are transformed, so that reading data displayed by the cuttings becomes impossible. As a result, for the DVD that corresponds to the CPRM, data recorded on the NBCA cannot be referenced so that the reproduced encoded data is not decoded. In addition, when someone who does not know a password stored in advance in the password storage unit operates the device, the delete operation cannot be performed. In addition, since confirmation of whether to perform the process of making the reproducing impossible is required, the delete operation may be stopped at this time.

According to another aspect of the invention, a recording and reproducing device for recording and reproducing data on an optical disk having a cutting data area in which data is rewritable and the data is displayed by laser cutting in a radiating direction. In the recording and reproducing device, when an instruction of making reproducing of the optical disk is input, data is deleted along a track by a pickup in a range where the cutting data area is formed in a radius direction of the optical disk. Further, when an instruction of making the reproducing of the optical disk impossible is input, the recording and reproducing device deletes data along a track by a pickup in a range where the cutting data area is formed in a radius direction of the optical disk.

In other words, in the cutting data area, data is displayed by laser cutting in a radiating direction. For this reason, laser light for deletion when a typical data deleting operation is performed is illuminated on the cutting data area along the track, and cuttings formed in advance in the radiating direction are transformed, so that reading data displayed by the cuttings becomes impossible. As a result, for the optical disk that corresponds to the CPRM, data recorded on the cutting data area may not be referenced so that encoding of the reproduced data cannot be decoded.

In addition, in addition to the above arrangement, the recording and reproducing device further comprises a password storage unit that stores a password inputted in advance. In the recording and reproducing device, when an input password accords with the password stored in the password storage unit, the delete operation is performed. In other words, when someone who does not know the password stored in advance in the password storage unit operates the device, the delete operation cannot be performed.

In addition, in addition to the above arrangement, when an instruction of making reproducing of the optical disk impossible is input, a display for requesting to confirm whether to perform the process of making the reproducing of the optical disk impossible is performed, and when an instruction of making the reproducing of the optical disk impossible is input in response to the display, the delete operation is performed. In other words, since confirmation of whether to perform the process of making the reproducing impossible is required, the delete operation may be stopped at this time.

According to the above-aspects of the invention, laser light for deletion when a data deleting operation is illuminated on the NBCA along the track, and cuttings formed in advance in the radiating direction are transformed, so that reading data displayed by laser cutting becomes impossible. In other words, information stored on the NBCA cannot be referenced so that the encoded data reproduced from the DVD that corresponds to the CPRM cannot be decoded. In addition, when someone who does not know the password stored in advance in the password storage unit operates the device, the delete operation cannot be performed. In addition, since confirmation of whether to perform the process of making the reproducing impossible is required, the delete operation may be stopped at this time. As a result, it is possible to change the optical disk corresponding to the CPRM into a disk of which the reproducing is surely impossible, to prevent an unqualified user from perform a process of making reproducing of a DVD impossible, and to prevent the process of making the reproducing of the DVD impossible from being inadvertently performed.

In addition, according to the above-aspects of the invention, laser light for deletion when a data deleting operation is performed is illuminated on the cutting data area along the track, and cuttings formed in advance in the radiating direction are transformed, so that reading data displayed by the cuttings becomes impossible. In other words, information recorded on the cutting data area cannot be referenced so that the reproduced encoded data cannot be decoded. For this reason, it is possible to change the optical disk corresponding to the CPRM into a disk of which the reproducing is surely impossible. Therefore, even when the discarded optical disk corresponding to the CPRM is an optical disk having private information recorded thereon, privacy can be protected.

Furthermore, when someone who does not know the password stored in advance in the password storage unit operates the device, the delete operation cannot be performed. For this reason, it is possible to prevent an unqualified user from perform a process of making reproducing of an optical disk impossible.

Furthermore, since confirmation of whether to perform the process of making the reproducing impossible is required, it is possible to prevent the process of making the reproducing of the optical disk impossible from being inadvertently performed.

### BRIEF DESCRIPTION OF THE DRAWINGS

These and other objects and advantages of this invention will become more fully apparent from the following detailed description taken with the accompanying drawings in which:

FIG. 1 is a block diagram showing an electrical arrangement of a DVD recorder being a recording and reproducing device according to an embodiment of the present invention;

FIG. 2 is a diagram showing a shape of divided area in a radius direction of a DVD-RW (optical disk) used to the embodiment of the invention;

FIG. 3 is a flowchart showing an essential operation of the embodiment when a process of making reproducing impossible is performed; and

FIG. 4 is an explanation view of a message displayed when a DVD does not correspond to a CPRM.

### DESCRIPTION OF THE PREFERRED EMBODIMENTS

Exemplary embodiments of the present invention will now be described with reference to the accompanying drawings.

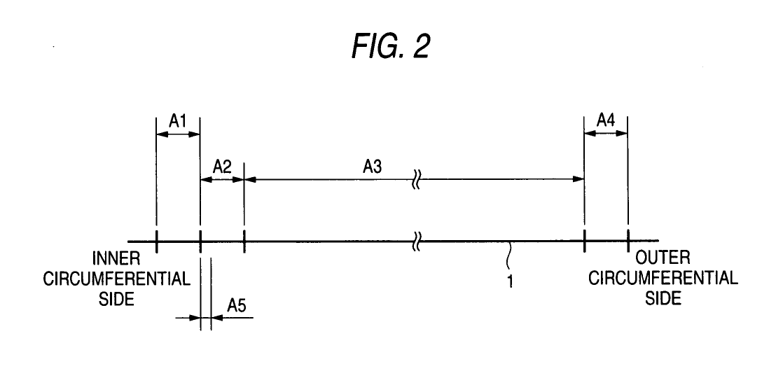

FIG. 2 is a diagram showing a shape of divided areas in a radius direction of a DVD-RW (optical disk) used in embodiments of the invention.

An area A1 in the innermost side of a DVD-RW 1 is an R information area, which is used for illuminating an optimal recording power. In other words, when recording begins, optimal recording conditions such as intensity of laser light are found from a test recording, and recoding conditions at that time is stored. An area A2 at the circumferential side adjacent to the area A1 is a read-in area, which is used for recording the last recording address when data is recorded on the data area A3. In addition, one piece of the CPRM, i.e., a media key block (MKB) is recorded.

An area A5 at an inner circle of the read-in area A2 has a narrow burst cutting area (NBCA) formed thereon, which corresponds to a cutting data area appended in claims and on which data is recorded by laser cutting in a radiating direction, and an album ID, which is one piece of information of the CPRM, is recorded. An area A3 at the circumferential side of the read-in area A2 is a data area, and data such as video signals are recorded. In addition, an area A4 at the outermost circumferential side is a read-out area.

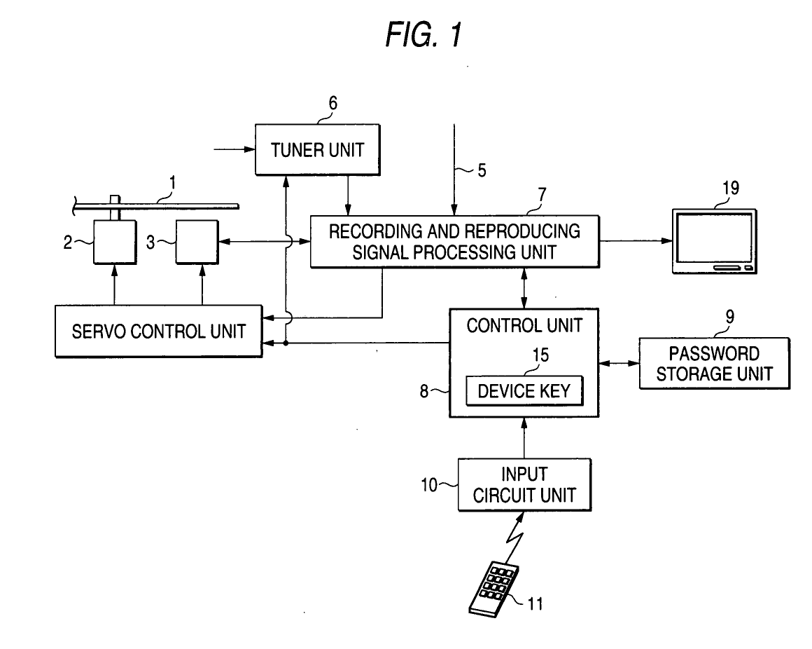

FIG. 1 is a block diagram showing an electrical arrangement, specifically, a DVD recorder of a recording and reproducing device according to an embodiment of the present invention.

A pickup 3 reads data recorded on the DVD-RW 1 rotatably driven by a spindle motor 2 and outputs the obtained signals to a recording and reproducing signal processing unit 7. In addition, signals output from the recording and reproducing signal processing unit 7 is recorded on the DVD-RW 1 using laser light. In addition, data recording on the DVD-RW 1 is deleted with laser light.

A servo control unit 4 controls focusing or tracking of the pickup 3, based on an error signal output from the recording and reproducing signal processing unit 7. In addition, based on a clock signal refreshed at the recording and reproducing signal processing unit 7, a rotational speed of the spindle motor 2 is controlled. In addition, based on an instruction from the control unit 8, the pickup 3 is moved in the radius direction by driving a thread motor (not shown).

A tuner unit 6 receives a commercial broadcasting channel directed from a control unit 8 while outputting received and obtained analog video signals to the recording and reproducing signal processing unit 7. The input circuit unit 10 includes key switches such as a power supply key arranged on the front panel of an apparatus main body (not shown) or a light receiving unit that receives infrared signals transmitted from a remote controller 11, and when an instruction is input from a user, the input circuit unit 10 outputs the input instruction to the control unit 8.

The recording and reproducing signal processing unit 7 demodulates digital data from the signals output from the pickup while reproducing, and at the same time performs a process such as an error correction. In addition, when the DVD-RW 1 corresponds to the CPRM, encoded data is decoded based on an album ID recorded on the NBCA, the MKB recorded on the read-in area A2, and a device key 15 (described later in detail) recorded in advance into the control unit 8. Next, video signals or voice signals obtained by releasing the encoding are decoded to output to the television receiver 19.

In addition, when the video signals output from the tuner unit 6 are recorded, the recording and reproducing signal processing unit 7 digitizes video signals output from the tuner unit 6 and compresses or decodes the digitized video signals. The compressed or decoded video signals are output to the pickup 3 and are recorded into the DVD-RW 1. In addition, when the video signals 5 provided from the external are signals that correspond to the CPRM, the recording and reproducing signal processing unit 7 encodes the video signals based on the album ID, the MKB, and the device key 15. Next, the signals obtained by decoding the encoded video signals are output to the pickup 3 and recorded into the DVD-RW 1.

In addition, with an on-screen display unit (not shown), signals indicating characters or symbols directed from the control unit 8 are generated, and overlapped with the video signals. Further, when the MKB is recorded on the DVD-RW 1, the MKB that is read out is output to the control unit 8. In addition, when the NBCA is formed on the DVD-RW 1, the data recorded on the NBCA (such as album ID) are read and output to the control unit 8.

The password storage unit 9 includes non-volatile memory devices, and stores the password input in advance. In addition, when deletion is performed in a formation range of the NBCA for the DVD-RW 1, it is determined whether the password input in response to a request is correct.

For example, the device key 15 is, as information stored in advance in a microcomputer, information given from a license management company to a manufacturer that manufactures DVD recorders and the like. In addition, this key becomes unique information, which is not limited to identifying the manufacturer but serves to enable each device to be identified individually as well.

The control unit 8, including a microcomputer, controls a basic operation as a recorder. In other words, according to a user instruction input to the remote controller 11 and the like, the control unit 8 controls the recording and reproducing signal processing unit 7 to reproduce the video signals recorded on the DVD-RW 1 and to display the video signals on the television receiver 19. In addition, the control unit 8 controls the tuner unit 6 and the recording and reproducing signal processing unit 7 to record a program from a channel indicated by the user on the DVD-RW 1.

In addition, when the DVD-RW 1 is a disk corresponding to the CPRM for reproducing, the control unit 8 determines whether reproducing is available by referencing the album ID, the MKB, and the device key 15 output from the recording and reproducing signal processing unit 7. In addition, when reproducing is available, the DVD-RW 1 is reproduced, and when reproducing is not available the DVD-RW 1 is not reproduced.

In addition, when the instruction of making reproducing of the DVD-RW 1 impossible is input, the control unit 8 requests a password input. Further, when the input password accords with the password stored in the passwords storage unit 9, a message that requests to confirm whether to perform the process of making reproducing impossible is displayed. When the instruction of making reproducing impossible is input corresponding to the confirmation message, data is deleted along the track by the pickup for a range where the cutting data area is formed in the radius direction of the optical disk.

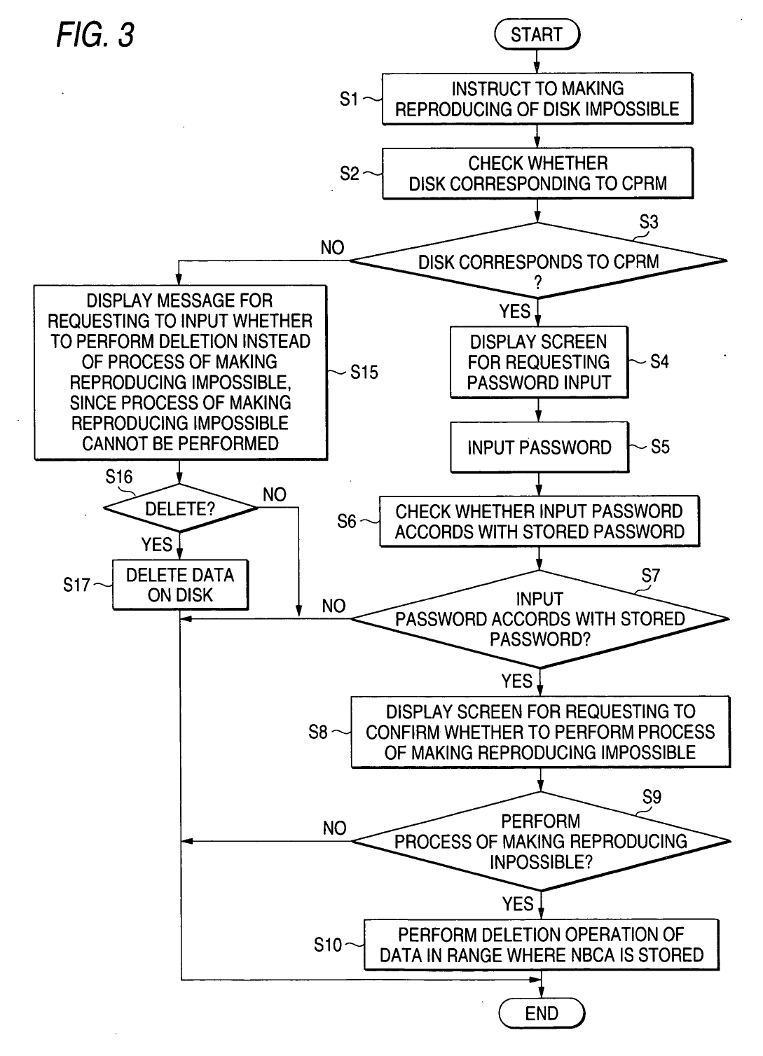

FIG. 3 is a flowchart showing an essential operation of the embodiment in a case of making reproducing of the DVD-RW 1 impossible. The operation of the embodiment is described with reference to FIG. 3, if needed.

For the operation of an initial setting, the control unit 8 requests a password input for reference when the operation of making the reproducing impossible is performed, and stores the input password into the password storage unit 9. After the password is stored to the password storage unit 9, when the instruction of making the reproducing of the DVD-RW 1 impossible is input (Step S1), the control unit 8 checks whether the DVD-RW 1 is a disk corresponding to the CPRM (step S2). When the DVD-RW 1 is a disk corresponding to the CPRM, a screen (not shown) that requests a password input is displayed on the television receiver 19 (Steps S3 and S4).

When the password is input (Step S5), it is checked that the input password accords with the password stored in the password storage unit 9 (Step S6). If the input password accords with the password stored in the password storage unit 9, the user is qualified to perform the reproduce-disabling operation so that a screen that requests to confirm whether to perform the process of making the reproducing impossible is displayed on the television receiver (Steps S7 and S8). When the instruction of making the reproducing impossible is input in response to the confirmation screen that indicates whether to perform the process of making the reproducing impossible, the control unit 8 controls the servo control unit 4 and the recording and reproducing signal processing unit 7 to perform a typical data delete operation along the track within the range A5 of the DVD-RW 1 where the NBCA is formed.

When the typical data delete operation is performed along the track within the range A5, laser light is illuminated from the pickup 3 to the cutting in the radiating direction on the NBCA. Meanwhile, the cutting formed on the NBCA is a cutting formed by the laser cutting. For this reason, even when laser light for deleting data along the track is illuminated, the cutting in the radiating direction on the NBCA is modified. As a result, data displayed by the cutting formed on the NBCA will be non-readable later.

In addition, when data recorded on the NBCA is non-readable, the album ID cannot be known. Therefore, the encoding of the reproduced data cannot be decoded. In other words, the reproducing is impossible. In addition, since a process of making reading of the NBCA impossible is a one-way process, after this process, a process of making the reading of data from the NBCA possible cannot be performed. In other words, the operation of reliably making the reproducing impossible operation can be performed.

In addition, in the range where the deleting is performed, there is eccentricity of the DVD-RW 1. Therefore, control is made such that the delete operation is performed onto an area wider than the range A4 where the NBCA is actually formed, by the width corresponding to a maximum amount of the eccentricity to the inner and outer circumferential sides.

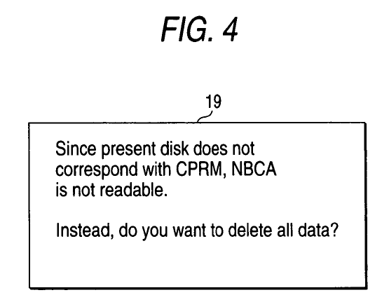

In addition, upon determining the step S3, when the DVD-RW 1 is not a disk corresponding to the CPRM, reproducing DVD-RW 1 is enabled without using the data stored on the NBCA. For this reason, the control unit 8 cannot perform the process of making the reproducing impossible. Therefore, a screen that requests an input instructing whether the data delete process is performed instead of the process of making the reproducing impossible is displayed on the television receiver 19, as shown in FIG. 4 (Step S15). When the instruction of performing the data delete process is input, the entire data of the DVD-RW 1 is deleted (Steps S16 and S17). Further, when the instruction of indicating not to delete data is input in response to the screen that requests an input instructing whether the data deleted process is performed or not, the processing ends.

In addition, in the case of checking whether the input password accords with the password stored in the password storage unit 9 in the step S7, when the input password does not accords with the password stored in the password storage unit 9, it is determined that someone who is unqualified for making the reproducing impossible is operating the device, and accordingly, the processing is ended. In addition, in the case of confirming whether to perform the process of making the reproducing impossible in the step S9, even when the instruction of indicating not to perform the process of making the reproducing impossible is input, the control unit 8 finishes the processing.

In addition, the present invention is not limited to the afore-mentioned embodiments, but may be applied in the same manner to a case the data recording and reproducing is performed on other optical disks corresponding to the CPRM (for example, DVD-RAMs corresponding to the CPRM).

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. A DVD recorder for recording and reproducing data on a DVD having an NBCA in which data is rewritable and the data is displayed by laser cutting in a radiating direction, the DVD recorder comprising;
a password storage unit that stores a password inputted in advance, wherein a password input is requested when an instruction of making reproducing of the DVD impossible is input,
wherein a display for requesting to confirm whether to perform the process of making the reproducing of the DVD impossible is performed when the input password accords with the password stored in the password storage unit, and
wherein data is deleted along a track by a pickup in a range where the NBCA is formed in a radius direction of the DVD when the instruction of performing to make the reproducing of the DVD is input in response to the display.

2. A recording and reproducing device for recording and reproducing data on an optical disk having a cutting data area in which data is rewritable and the data is displayed by laser cutting in a radiating direction,
wherein when an instruction of making reproducing of the optical disk is input, and
data is deleted by a pickup in a range where the cutting data area is formed in a radius direction of the optical disk.

3. The recording and reproducing device according to claim 2, comprising:
a password storage unit that stores a password inputted in advance,
wherein when an input password accords with the password stored in the password storage unit, a delete operation is performed.

4. The recording and reproducing device according to claim 2,
wherein when an instruction of making reproducing of the optical disk impossible is input, a display for requesting to confirm whether to perform the process of the making the reproducing of the optical disk impossible is performed, and
wherein when an instruction of making the reproducing of the optical disk impossible is input in response to the display, the delete operation is performed.

5. The recording and reproducing device according to claim 3,
wherein when an instruction of making reproducing of the optical disk impossible is input, a display for requesting to confirm whether to perform the process of the making the reproducing of the optical disk impossible is performed, and
wherein when an instruction of making the reproducing of the optical disk impossible is input in response to the display, the delete operation is performed.
